(19) United States
(12) Patent Application Publication
(10) Pub. No.: US 2024/0175143 A1
(43) Pub. Date: May 30, 2024

(54) WATER ELECTROLYSIS CELL STACK AND METHOD FOR MANUFACTURING THE SAME

(71) Applicant: TOYOTA JIDOSHA KABUSHIKI KAISHA, Toyota-shi (JP)

(72) Inventor: Toshiaki KUSAKARI, Sunto-gun (JP)

(73) Assignee: TOYOTA JIDOSHA KABUSHIKI KAISHA, Toyota-shi (JP)

(21) Appl. No.: 18/488,303

(22) Filed: Oct. 17, 2023

(30) Foreign Application Priority Data
Nov. 28, 2022 (JP) 2022-188997

(51) Int. Cl. C25B 1/04; C25B 9/21; C25B 9/70

(52) U.S. Cl. CPC C25B 1/04; C25B 9/21; C25B 9/70

(57) ABSTRACT

A water electrolysis cell stack includes a plurality of water electrolysis cells stacked on each other. The water electrolysis cell stack is characterized in that the water electrolysis cells are located adjacent to each other, the water electrolysis cell has an anode separator and a cathode separator, each of the anode separator and the cathode separator has, on its front and back, grooves serving as channels, and a resin is located in at least part of clearance between the adjacent water electrolysis cells in a region where the grooves are located.

### CROSS-REFERENCE TO RELATED APPLICATION

This application claims priority to Japanese Patent Application No. 2022-188997 filed on Nov. 28, 2022, incorporated herein by reference in its entirety.

### BACKGROUND

### 1. Technical Field

The present disclosure relates to water electrolysis cell stacks and methods for manufacturing the same.

### 2. Description of Related Art

Various studies have been conducted on water electrolysis devices. For example, Japanese Unexamined Patent Application Publication No. 2015-089949 (JP 2015-089949 A) discloses a water electrolysis cell stack composed of water electrolysis cells stacked on each other and each having separators on a hydrogen electrode side and an oxygen electrode side.

### SUMMARY

The water electrolysis cell stack described in JP 2015-089949 A has no clearance between the water electrolysis cells. This water electrolysis cell stack therefore has a problem that the separators may be deformed by the pressure of hydrogen generated by water electrolysis.

The present disclosure was made in view of the above circumstances, and it is an object of the present disclosure to provide a water electrolysis cell stack with improved pressure resistance and a method for manufacturing the same.

The present disclosure provides a water electrolysis cell stack having the following characteristics.

The water electrolysis cell stack according to the present disclosure is a water electrolysis cell stack including a plurality of water electrolysis cells stacked on each other.
The water electrolysis cells are located adjacent to each other.
The water electrolysis cell includes an anode separator and a cathode separator.
Each of the anode separator and the cathode separator has, on front and back of the separator, grooves serving as channels.
A resin is located in at least part of clearance between the adjacent water electrolysis cells in a region where the grooves are located.

In the water electrolysis cell stack of the present disclosure, a filling ratio of the resin in the clearance may be 30% or more.

In the water electrolysis cell stack of the present disclosure, the resin may be at least one selected from the group consisting of polyethylene, polystyrene, acrylonitrile-butadiene-styrene resin, polypropylene, polycarbonate, polyether sulfone, polyether ether ketone, modified polyphenylene ether, acrylonitrile-ethylene-propylene-diene-styrene resin, polyamide, and polyimide.

The present disclosure provides a method for manufacturing a water electrolysis cell stack that has the following characteristic.

The method for manufacturing a water electrolysis cell stack according to the present disclosure is a method for manufacturing the water electrolysis cell stack, the method including filling the clearance with the resin by injection molding.

The water electrolysis cell stack of the present disclosure has improved pressure resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating an example of a water electrolysis cell stack according to the present disclosure.

### DETAILED DESCRIPTION OF EMBODIMENTS

An embodiment according to the present disclosure will be described below. Note that matters other than those specifically mentioned in the present specification and necessary for the implementation of the present disclosure (for example, a general configuration and a manufacturing process of a water electrolysis cell stack that does not characterize the present disclosure) can be understood as design matters of a person skilled in the art based on the prior art in the field. The present disclosure may be carried out based on the content disclosed in the present specification and the common general technical knowledge in the field.

Also, the dimensional relationships (length, width, thickness, etc.) in the drawings do not reflect the actual dimensional relationships.
In the present specification, the term “to” indicating a numerical range is used in the sense of including the numerical values described before and after the term as a lower limit value and an upper limit value.
Any combination of the upper limit value and the lower limit value in the numerical range can be adopted.

The present disclosure provides a water electrolysis cell stack having the following characteristics.

The water electrolysis cell stack according to the present disclosure is a water electrolysis cell stack including a plurality of water electrolysis cells stacked on each other.
The water electrolysis cells are located adjacent to each other.
The water electrolysis cell includes an anode separator and a cathode separator.
Each of the anode separator and the cathode separator has, on front and back of the separator, grooves serving as channels.

A resin is located in at least part of clearance between the adjacent water electrolysis cells in a region where the grooves are located.

In general, since the water electrolysis cell stack increases the pressure of hydrogen generated by the water electrolysis, it is necessary to increase the pressure resistance in comparison with the fuel cell stack. The internal pressure of the water electrolysis cell stack is about the maximum 3 MPa, and the internal pressure of the fuel cell stack is about the maximum 0.3 MPa. On the other hand, it is difficult to convert a separator for a fuel cell to a separator for a water electrolysis cell as it is. The water electrolysis cell also uses water supplied for water electrolysis as a cooling medium, and in many cases, cooling medium channels that are necessary for a single cell of the fuel cell are not necessary for the water electrolysis cell.

In the present disclosure, a fuel cell stack having oxidant gas channels, fuel gas channels, and cooling medium channels is applied to a water electrolysis cell stack. In the present disclosure, the cooling medium channels are filled with a resin in order to reduce deformation of and damage to the separators by the pressure of the gas flowing through the fuel gas channels and the cooling medium channels. According to the present disclosure, by press molding, even in a separator having, on its front and back, grooves serving as channels, it is possible to improve the pressure resistance of the water electrolysis cell stack by filling the clearance between adjacent water electrolysis cells with a resin. In the present disclosure, the production efficiency of the water electrolysis cell stack can be improved by applying the fuel cell stack to the water electrolysis cell stack.

In the water electrolysis cell of the present disclosure, water supplied to an anode (oxygen electrode) is electrolyzed, oxygen is generated from the anode, and hydrogen is generated from the cathode (hydrogen electrode).

Anode: H₂O→2H⁺+½O₂+2e⁻

Cathode: 2H⁺+2e⁻→H₂

In the water electrolysis cell of the present disclosure, the pressure of the hydrogen electrode in the water electrolysis cell may be higher than the pressure of the oxygen electrode.

The water electrolysis cell stack of the present disclosure is a stacked body in which a plurality of water electrolysis cells are stacked.

The plurality of water electrolysis cells are adjacent to each other.
The number of stacked water electrolysis cells is not particularly limited, and may be, for example, 2 to several hundred.

The water electrolysis cell may include a membrane-electrode assembly (MEA).

The membrane electrode assembly includes an anode, an electrolyte membrane, and a cathode in this order.
The anode (oxygen electrode) in the present disclosure includes an anode catalyst layer, and may optionally include an anode-side gas diffusion layer.
The cathode (hydrogen electrode) in the present disclosure includes a cathode catalyst layer, and may optionally include a cathode-side gas diffusion layer.
The anode-side gas diffusion layer, the anode catalyst layer, the electrolyte membrane, the cathode catalyst layer, and the cathode-side gas diffusion layer are collectively referred to as a membrane electrode gas diffusion layer assembly (MEGA).

The cathode catalyst layer and the anode catalyst layer are collectively referred to as a catalyst layer.

The catalyst layer may include, for example, a catalyst metal that promotes water electrolysis, an electrolyte having proton conductivity, a support having electron conductivity, and the like.
As the catalytic metal, for example, iridium (Ir), iridium dioxide (IrO₂), ruthenium (Ru), platinum (Pt), and an alloy composed of Pt and another metal (for example, a Pt alloy obtained by mixing cobalt, nickel, and the like) can be used. The anode catalyst layer may use, for example, Ir, IrO₂, and Ru as catalyst metals, and the cathode catalyst layer may use, for example, Pt, and Pt alloys as catalyst metals.
The electrolyte may be fluorine-based resin or the like. As the fluorine-based resin, for example, Nafion solution or the like may be used.
The catalyst metal is supported on a carrier, and each catalyst layer may contain a mixture of a carrier supporting the catalyst metal (catalyst-supporting carrier) and an electrolyte.
Examples of the carrier for supporting the catalyst metal include commercially available carbon materials such as carbon.

The electrolyte membrane may be a solid polymer electrolyte membrane. Examples of the solid polymer electrolyte membrane include fluorine-based electrolyte membranes such as perfluorosulfonic acid thin films containing water, and hydrocarbon-based electrolyte membranes. As the electrolyte membrane, for example, a Nafion membrane (produced by DuPont) may be used.

The anode-side gas diffusion layer and the cathode-side gas diffusion layer are collectively referred to as a gas diffusion layer.

The gas diffusion layer may be a gas permeable, that is, a conductive member having pores. Examples of the conductive member include carbon porous members such as carbon cloth and carbon paper, and metal porous members such as 3D fine mesh, metal mesh, and foamed metal.
The gas diffusion layer may have pores of 1 to several hundred μm.

The water electrolysis cell includes an anode separator and a cathode separator.

Each of the anode separator and the cathode separator has, on front and back of the separator, grooves serving as channels.
The anode separator and the cathode separator are collectively referred to as a separator.
The separator may have channels for a reactant fluid such as reactant water, oxygen, or hydrogen on a surface in contact with the gas diffusion layer. In addition, the separator may have channels for a cooling medium for keeping the temperature of the water electrolysis cell constant on the surface opposite to the surface in contact with the gas diffusion layer.
The anode separator may have channels for an anode fluid such as reactive water or oxygen on a surface in contact with the anode-side gas diffusion layer. In addition, the anode separator may have channels for a cooling medium for keeping the temperature of the water electrolysis cell constant on the surface opposite to the surface in contact with the anode-side gas diffusion layer.
The cathode separator may have channels for a cathode fluid such as hydrogen on a surface in contact with the cathode-side gas diffusion layer. The cathode separator may have channels for a cooling medium for keeping the temperature of the water electrolysis cell constant on the surface opposite to the surface in contact with the cathode-side gas diffusion layer.
The separator may have holes serving as manifolds such as supply holes and discharge holes for allowing fluids such as reaction water, oxygen, hydrogen, and a cooling medium to flow in the stacking direction of the water electrolysis cell. As the reaction water and the cooling medium, water or the like can be used.
Examples of the supply hole include an anode supply hole, a cathode supply hole, and a cooling medium supply hole.
Examples of the discharge hole include an anode discharge hole, a cathode discharge hole, and a cooling medium discharge hole.
The separator may be a gas-impermeable electroconductive member or the like. The gas-impermeable conductive member may be, for example, dense carbon obtained by compressing a resin material such as a thermosetting resin, a thermoplastic resin, and a resin fiber, and a carbon material such as a carbon powder and a carbon fiber to make it gas-impermeable, or a press-molded metal (for example, titanium, stainless steel, or the like) plate.
The shape of the separator may be a rectangle, a horizontally long hexagon, a horizontally long octagon, a circle, an oblong shape, and the like.

The water electrolysis cell may have a frame having an opening.

The opening of the frame may be in the center of the frame.
The opening of the frame accommodates the membrane electrode assembly or the membrane electrode gas diffusion layer assembly.
The frame may have a hole serving as a manifold in a region other than the end portion and the opening portion in the plane direction in a plan view. The holes that the frame has are the same as those that the separator has.
The frame may be a structural member having adhesiveness, gas sealing, and insulating properties. The material of the frame may be, for example, a thermoplastic resin such as a polyester-based resin or a modified olefin-based resin, or a thermosetting resin that is a modified epoxy resin. The frame may be made of a rubber material having an elastic function such as ethylene propylene diene rubber (EPDM), fluorine-based rubber, or silicone-based rubber.
The thickness of the frame may be 5 μm or more, 20 μm or more, or 200 μm or less, or 150 μm or less, from the viewpoint of reducing the thickness of the water electrolysis cell, from the viewpoint of ensuring the insulating property.

The water electrolysis cell stack may include a manifold such as an inlet manifold in which the supply holes communicate with each other and an outlet manifold in which the discharge holes communicate with each other.

Inlet manifolds include anode inlet manifolds, cathode inlet manifolds, and cooling medium inlet manifolds.
Outlet manifolds include anode outlet manifolds, cathode outlet manifolds, and cooling medium outlet manifolds.
A cooling medium inlet manifold and a cooling medium outlet manifold are collectively referred to as a cooling medium manifold.

In the water electrolysis cell stack of the present disclosure, a resin is located in at least part of clearance between the adjacent water electrolysis cells in a region where the grooves are located. The region in which the resin is located may be at least part or all of the region between the adjacent water electrolysis cells in which the cooling medium channels of the separator are formed. In addition, a resin may be disposed on the entire cooling medium manifold of the water electrolysis cell stack.

A filling ratio of the resin in the clearance between the adjacent water electrolysis cells may be 30% or more.
The resin may be at least one selected from the group consisting of polyethylene, polystyrene, acrylonitrile-butadiene-styrene (ABS) resin, polypropylene, polycarbonate, polyether sulfone, polyether ether ketone, modified polyphenylene ether, acrylonitrile-ethylene-propylene-diene-styrene (AES) resin, polyamide, and polyimide.

A method for manufacturing a water electrolysis cell stack of the present disclosure may include filling the clearance between the adjacent water electrolysis cells with the resin by injection molding. The injection molding may be a foam injection molding. By the foam injection molding, the filling ratio of the resin in the clearance between the adjacent water electrolysis cells can be controlled, and the weight of the water electrolysis cell stack can be reduced.

The resin used for the foam injection molding may be, among the above resins, modified polyphenylene ether, polypropylene, polycarbonate, acrylonitrile ethylene propylene diene styrene (AES) resin, polyamide, or the like.
A water electrolysis cell stack may first be manufactured by stacking water electrolysis cells, and then resin filling may be performed by injection molding through a cooling medium manifold of the water electrolysis cell stack. Thus, the production efficiency of the water electrolysis cell stack can be improved.

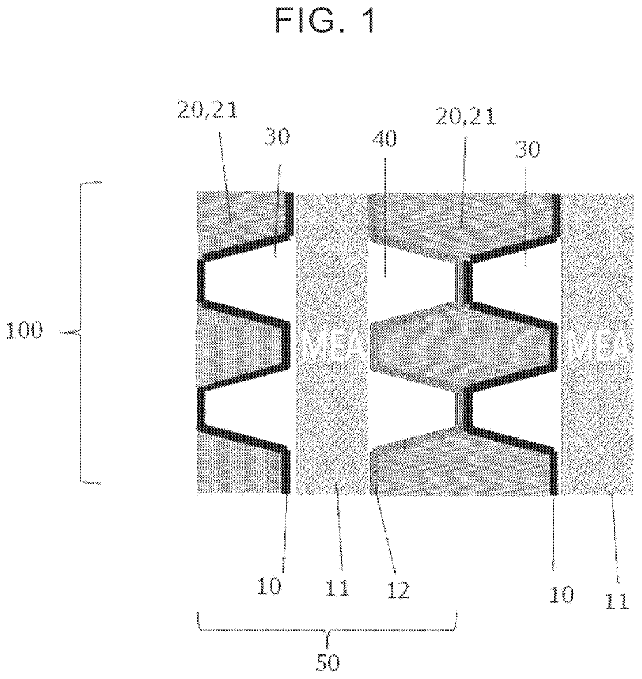

FIG. 1 is a schematic cross-sectional view illustrating an example of a water electrolysis cell stack of the present disclosure.

As shown in FIG. 1, the water electrolysis cell stack 100 of the present disclosure is a stacked body in which a plurality of water electrolysis cells 50 are stacked. The water electrolysis cell 50 includes an anode separator 10, a membrane-electrode assembly (MEA) 11, and a cathode separator 12). Cooling medium channels 20 are provided on a surface of the anode separator 10 and the cathode separator 12 opposite to the membrane electrode assembly 11. Anode fluid channels 30 are provided on a surface of the anode separator 10 on the membrane electrode assembly 11 side. Cathode fluid channels 40 are provided on a surface of the cathode separator 12 on the membrane electrode assembly 11 side. The resin 21 is located in the clearance between the adjacent water electrolysis cells 50 in the region where the cooling medium channels 20 are located. By filling the clearance between the adjacent water electrolysis cells 50 with the resin 21, the pressure resistance of the water electrolysis cell stack 100 can be improved.

What is claimed is:

1. A water electrolysis cell stack comprising a plurality of water electrolysis cells stacked on each other, wherein:
the water electrolysis cells are located adjacent to each other;
the water electrolysis cell includes an anode separator and a cathode separator;
each of the anode separator and the cathode separator has, on front and back of the separator, grooves serving as channels; and
a resin is located in at least part of clearance between the adjacent water electrolysis cells in a region where the grooves are located.

2. The water electrolysis cell stack according to claim 1, wherein a filling ratio of the resin in the clearance is 30% or more.

3. The water electrolysis cell stack according to claim 1, wherein the resin is at least one selected from the group consisting of polyethylene, polystyrene, acrylonitrile-butadiene-styrene resin, polypropylene, polycarbonate, polyether sulfone, polyether ether ketone, modified polyphenylene ether, acrylonitrile-ethylene-propylene-diene-styrene resin, polyamide, and polyimide.

4. A method for manufacturing the water electrolysis cell stack according to claim 1, the method comprising filling the clearance with the resin by injection molding.
